(19) United States
(12) Patent Application Publication
(10) Pub. No.: US 2017/0347722 A1
(43) Pub. Date: Dec. 7, 2017

(54) MOSQUITO-REPELLING WEARABLES

(71) Applicant: SKL Apparel LLC, Midland, TX (US)

(72) Inventor: Kristina Johnson, Midland, TX (US)

(21) Appl. No.: 15/614,957

(22) Filed: Jun. 6, 2017

Related U.S. Application Data
(60) Provisional application No. 62/346,185, filed on Jun. 6, 2016.

(51) Int. Cl. A41D 13/00; A01N 25/34

(52) U.S. Cl. CPC A41D 13/001; A01N 25/34

(57) ABSTRACT

Wearables are provided that prevent—or at least greatly reduce the risk of—mosquito bites by having repellent within the mesh tightly bonded into the actual fibers of the fabric, thereby providing built-in protection from mosquitoes, ticks and other potentially dangerous biting insects. These wearables may be both practical and fashion-forward in design so that humans will be less likely to object to wearing them. Wearables may include track suits, jackets and wraps; however, wearables may take different forms, including but not limited to, pant coverings, wrist bands, hats, scarves, and patches. These wearables may be worn when participating in various outdoor activities, including, but not limited to, playing, bike riding, and camping. These wearables also may be breathable and easy to put on and take off, as well as appealing in appearance.

### CROSS REFERENCE TO RELATED APPLICATION

This application claims the benefit under 35 U.S.C. §119(e) of U.S. Provisional Patent Application Ser. No. 62/346,185 filed on Jun. 6, 2016, entitled “Mosquito-Repelling Wearables,” which is incorporated by reference in its entirety.

### FIELD OF THE DISCLOSURE

The present disclosure generally relates to mosquito-repellent wearables, and more particularly to mosquito-repellent wearables providing a repellent-treated mesh barrier between mosquitoes and skin.

### BACKGROUND

Humans (as well as their pets) often like to be outside in the summer months when mosquitoes are prevalent. It can be a challenge to protect skin from the threat of mosquito bites, particularly when mosquitoes are small in size and difficult to detect sometimes until they have already bitten the skin. Humans can react to mosquito bites differently. Problems can range from itchy red bumps on the skin to allergic reactions resulting in fever, redness, swelling and even cellulitis to deadly diseases.

There are thousands of mosquito species, and different species can carry different diseases, including malaria, yellow fever, West Nile Virus, and now the Zika virus. In places where these diseases easily spread, humans can be at risk of dying from a mosquito bite. For example, according The World Health Organization, “about 3.2 billion people—nearly half of the world's population—are at risk of malaria. In 2015, there were an estimated 214 million new cases of malaria, and approximately 438,000 deaths.” (WHO, 2015, “10 Facts on Malaria,” slide 2). In 2015, a child died from malaria at a rate of almost one per minute. (UNICEF, 2015).

One possible way to reduce potential mosquito bites is to avoid exposed skin, such as by wearing long-sleeved shirts and pants when outside; however, this can lead to a risk of overheating, particularly in the extreme heat of summer felt in many parts of the world. Another possible solution is to apply chemical sprays, such as those containing DEET, or oils, such as citronella, geraniol, and limonene to skin or clothing, but there are concerns about placing chemical-laden sprays or oils on skin, particularly the tender skin of children. There are some sprays and oils that are natural (i.e., not filled with chemicals), but they generally have not been as effective in repelling mosquitoes. Yet another possible solution is to wear clothing made from mosquito netting, but these types of suits are cumbersome to wear and also can be unappealing from a wearability standpoint. While each of these options may result in reduced risk of mosquito bites, they can lead to discomfort and/or harm.

### SUMMARY

Embodiments of the present disclosure may provide wearables that protect humans from mosquito bites. These wearables may be both practical and fashion-forward in design so that humans will be less likely to object to wearing them. While this disclosure may refer to mosquitoes, it should be appreciated that embodiments of the present disclosure may be used to protect against attacks by other insects, including, but not limited to, ticks, ants, flies, chiggers, and midges (no-see-ums), and this disclosure is intended to address each of these types of insects as well as others not specifically mentioned, unless otherwise specified.

Wearables according to embodiments of the present disclosure are generally described as track suits, jackets and wraps; however, it should be appreciated that wearables may take different forms without departing from the present disclosure, including but not limited to, pant coverings, wrist bands, hats, shorts, pants, belts, collar shirt, athletic wear, scarves, and patches.

Wearables according to embodiments of the present disclosure prevent—or at least greatly reduce the risk of—mosquito bites. These wearables may be worn by humans when participating in various outdoor activities, including, but not limited to, playing, working out, bike riding, and camping. These wearables also may be breathable, lightweight and/or easy to put on and take off, as well as appealing in appearance. They may provide protection wherever the wearer goes while reducing the potential problems associated with sprays, such as incomplete application.

Embodiments of the present disclosure may provide a mosquito-repelling wearable comprising a three-dimensional mesh and/or a single-layer repellent-treated mesh that is soft and breathable, wherein the repellent tightly bonds a permethrin formulation into fibers of the mesh. It should be appreciated that the three-dimensional mesh may or may not be repellent-treated in embodiments of the present disclosure. The wearable may be selected from the group comprising a track suit, a poncho, a caftan cover-up, a cover-up, a bunting, a jacket, a wrap, a pant covering, a wrist band, a hat, shorts, pants, a collar shirt, athletic wear, a scarf, and a patch. The wearable may be lightweight. The wearable may include a hood formed of the three-dimensional mesh and/or a single-layer repellent-treated mesh. The repellent nature of the wearable may last for approximately 25 launderings. The mesh may be stretchy and pliable. The wearable also may include a belting mechanism to provide closure for a front portion of the wearable. The wearable may be a track suit having a trouser portion that may cover a lower torso and legs of a wearer and a jacket portion that may cover an upper torso and arms of the wearer. The single-layer repellent-treated mesh may be a sheer stretch mesh formed of approximately 82% nylon and approximately 18% spandex; and milliskin tricot formed of approximately 80% nylon and approximately 20% spandex. The single-layer repellent-treated mesh alternatively may be comprised of sheer stretch mesh formed of approximately 82% nylon and approximately 18% spandex. A three-dimensional mesh may be used in addition to or in place of the single-layer repellent-treated mesh in some embodiments of the present disclosure. The wearable may have a springiness that may resist compression and reduction in thickness of the mesh when in use, thereby lessening the likelihood that a stinger of the mosquito penetrates a wearer's skin. The wearable may have sufficient ventilation to permit wearing during hot weather or when engaging in physical activity. The wearable may further include sensors, GPS sensors, Bluetooth sensors, Wi-Fi sensors, watches, heart rate monitor, humidity sensor, phone, touchscreen, display, graphical user interface, voice recognition interface, temperature sensor, watch, blood sugar monitor, panic button, camera, drone interface, and LTE/Wi-Fi/Bluetooth communication processors/sensors. The mesh may have a sufficient thickness to prevent a mosquito stinger bite from penetrating a wearer's skin, and that thickness may be approximately ⅛ inches thick.

Other embodiments of the present disclosure may provide a mosquito-repelling tracksuit comprising a trouser portion that covers a lower torso and legs of a wearer, the trouser portion including gatherings at the waistband and ankles formed of a ribbed material; and a jacket portion that covers an upper torso and arms of the wearer, the jacket portion including gatherings at the neck and wrists formed of the ribbed material, wherein the trouser portion and the jacket portion may be formed of a repellent-treated three-dimensional mesh that is soft and breathable, wherein the repellent tightly bonds a permethrin formulation into fibers of the mesh.

Further embodiments of the present disclosure may provide a mosquito-repelling cover-up comprising a body portion formed of a single-layer repellent-treated sheer stretch mesh formed of approximately 82% nylon and approximately 18% spandex, wherein the repellent tightly bonds a permethrin formulation into fibers of the mesh. The cover-up may further include a collar portion formed of a ribbed material and attached to the body portion. The cover-up also may include a hood attached to the collar portion of the cover-up, the hood formed of the repellent-treated mesh. The cover-up may be a wrap jacket.

### BRIEF DESCRIPTION OF THE DRAWINGS

For a more complete understanding of this disclosure, reference is now made to the following description, taken in conjunction with the accompanying drawings, in which:

FIG. 1A depicts a front view of a mosquito-repelling wrap jacket according to an embodiment of the present disclosure;

FIG. 1B depicts front and back views of mosquito-repelling wrap jackets as worn according to an embodiment of the present disclosure;

FIG. 1C depicts front and back views of a mosquito-repelling wrap jacket as worn according to an embodiment of the present disclosure;

FIG. 1D depicts a front/side view of a mosquito-repelling wrap jacket as worn according to an embodiment of the present disclosure;

FIG. 2A depicts a front view of a mosquito-repelling track suit as worn according to an embodiment of the present disclosure;

FIG. 2B depicts a front view of another mosquito-repelling track suit as worn according to an embodiment of the present disclosure;

FIG. 2C depicts a back view of a mosquito-repelling track suit as worn according to an embodiment of the present disclosure;

FIG. 2D depicts a front view of a mosquito-repelling track suit according to an embodiment of the present disclosure;

FIG. 2E depicts a back view of a mosquito-repelling track suit according to an embodiment of the present disclosure

FIG. 3A depicts a front view of a mosquito-repelling track jacket according to an embodiment of the present disclosure;

FIG. 3B depicts a front view of a mosquito-repelling track jacket as worn according to an embodiment of the present disclosure;

FIG. 4 depicts a mosquito-repelling mesh according to an embodiment of the present disclosure;

FIG. 5 depicts a close-up view of a mosquito-repelling fabric forming the track jackets of FIGS. 3A and 3B;

FIG. 6 depicts a view of mosquito-repelling pants according to an embodiment of the present disclosure;

FIG. 7A depicts a view of a mosquito-repelling infant bunting according to an embodiment of the present disclosure;

FIG. 7B depicts a view of a mosquito-repelling infant bunting being worn by an infant according to an embodiment of the present disclosure;

FIG. 8A depicts a mosquito-repelling cover-up according to an embodiment of the present disclosure;

FIG. 8B depicts another mosquito-repelling cover-up according to an embodiment of the present disclosure;

FIG. 9A depicts a front view of a mosquito-repelling poncho according to an embodiment of the present disclosure;

FIG. 9B depicts a back view of a mosquito-repelling poncho according to an embodiment of the present disclosure; and

FIG. 10 depicts a front view of a mosquito-repelling caftan cover-up according to an embodiment of the present disclosure.

### DETAILED DESCRIPTION

Embodiments of the present disclosure may provide mosquito-repelling wearables that may be formed of repellent-treated mesh that is soft and breathable as it protects the wearer from insect bites. In embodiments of the present disclosure, the repellent technology used to treat the mesh may tightly bond a permethrin formulation into the actual fibers of the fabric during manufacturing, resulting in effectively, odorless insect protection. Permethrin is a chemical that may be used as an insect repellent. It belongs to the family of synthetic chemicals called pyrethroids and functions as a neurotoxin, affecting neuron membranes by prolonging sodium channel activation, and it has been a U.S. Environmental Protection Agency (EPA)-registered chemical for almost 40 years, with an excellent safety record.

Inclusion of the permethrin formulation into the fibers of the fabric may repel insects, including but not limited to, mosquitoes, ticks, ants, flies, chiggers, and midges (no-see-ums). While wearables according to embodiments of the present disclosure have been described as including the permethrin formulation bonded with the mesh, it should be appreciated that other repellent formulations may be utilized without departing from the present disclosure.

The repelling nature of wearables according to embodiments of the present disclosure may last through approximately 25 launderings, which is the general expected lifetime of a garment. This life span is well beyond the life of most performance finishes commonly used in the technical-apparel industry.

Wearables according to embodiments of the present disclosure may be worn by adults and children alike. It should be appreciated that these wearables may be provided in a variety of colors, patterns, and styles, even including camouflage, according to embodiments of the present disclosure. In some embodiments of the present disclosure, these wearables may resemble mosquito netting but are formed of a three-dimensional mesh, similar to the top portion of running shoes; this mesh may breathe but will reduce the likelihood that a mosquito will penetrate the spongy fabric when worn. In further embodiments of the present disclosure, these wearables are formed of a single-layer repellent-treated mesh, either in place of or in addition to the three-dimensional mesh. It should be appreciated that the three-dimensional mesh may or may not be repellent-treated in embodiments of the present disclosure. These wearables may be worn in warmer climates; however, there may be embodiments of the present disclosure where heavier clothes may be worn underneath the wearable, such as when the climate is a little cooler but certain insects are still present. There may be further embodiments where more than one layer of repellent-treated mesh may be utilized, again when the climate is a little cooler.

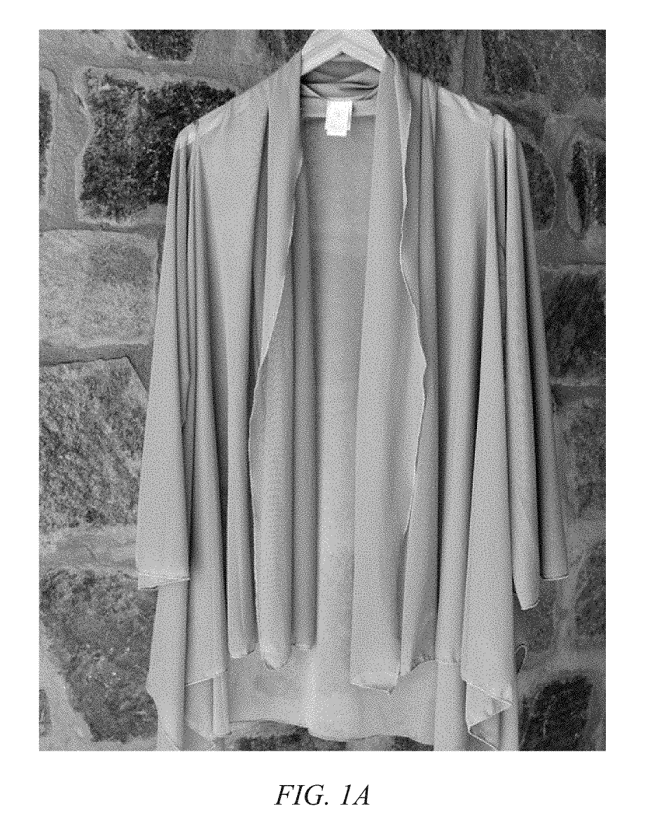

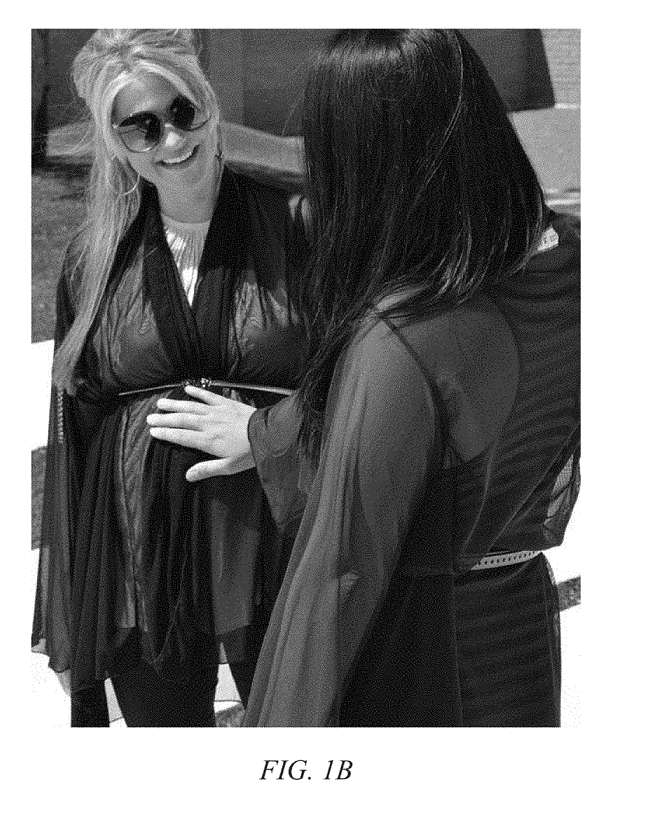

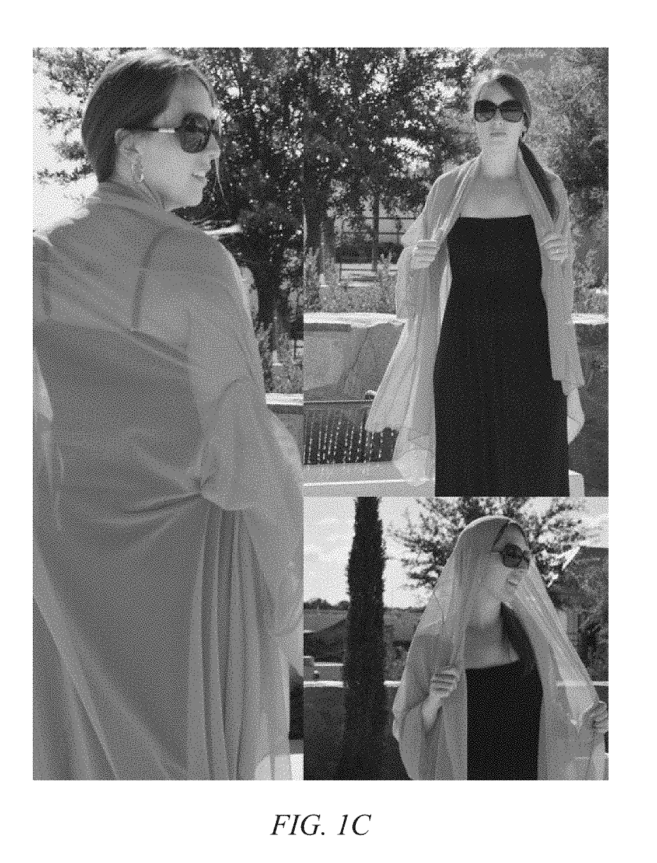

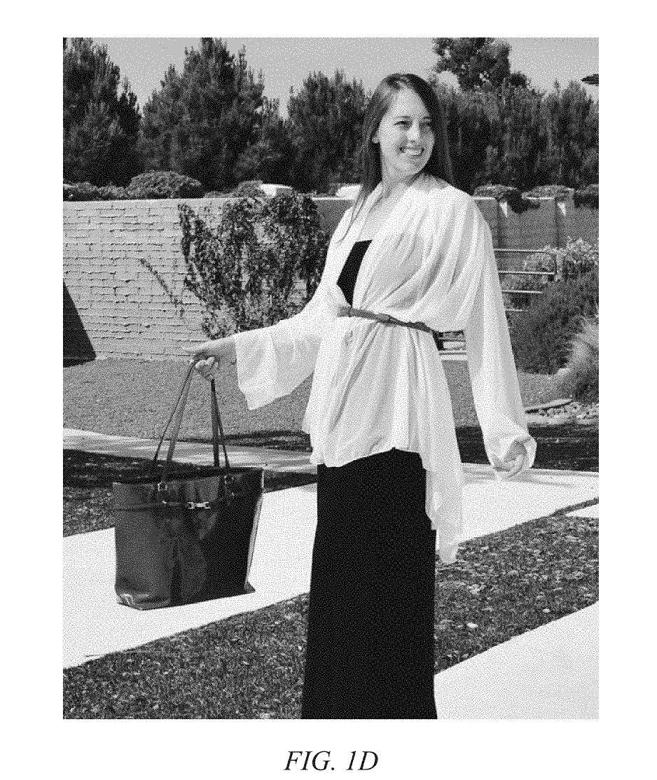

Embodiments of the present disclosure may provide a wrap jacket (see FIGS. 1A-1D) that is treated with the permethrin repellent formulation, provided by Insect Shield® in some instances. This type of jacket may be worn by women, including women that are pregnant and may be more susceptible to diseases such as the Zika virus. The jacket may be constructed of repellent-treated mesh that is soft, lightweight, and/or breathable as it helps protect the wearer from insect bites. The repellent within the mesh is tightly bonded into the actual fibers of the fabric, thereby providing built-in protection from mosquitoes, ticks and other potentially dangerous biting insects. The mesh forming this wearable may be soft, breathable and may be stretchy/pliable in nature. The repellent may be effective for approximately 25 launderings.

FIGS. 1A-1D depict different views of mosquito-repelling wrap jackets according to embodiments of the present disclosure. More specifically, FIG. 1A depicts a front view of a mosquito-repelling wrap jacket according to an embodiment of the present disclosure. In this embodiment, the wrap jacket is shown on a hanger (i.e., not being worn), and this reflects the draping nature of the wrap jacket. While the wrap jacket may be sold in a variety of sizes, it should be appreciated that the draping nature of the wrap jacket may allow for people of differing sizes and shapes to wear it, including pregnant women, such as the wrap jacket depicted in the front view of FIG. 1B. It also should be appreciated that wrap jackets according to embodiments of the present disclosure may be provided in varying colors, patterns, and styles.

FIG. 1B depicts front and back views of mosquito-repelling wrap jackets as worn according to an embodiment of the present disclosure. In this embodiment, belting mechanisms have been utilized to provide closure for the front of the wrap jacket, and the back view illustrates how the belting mechanism may wrap around the wearer.

FIG. 1C depicts front and back views of a mosquito-repelling wrap jacket as worn according to an embodiment of the present disclosure. In this embodiment, the draping nature of the wrap jacket is visible from the back view. Further, one of the front views depicts how the wrap jacket may be drawn over a wearer's head in some embodiments of the present disclosure to provide additional protection for the wearer's face, neck and head. However, there may be other embodiments wherein one may wear the wrap jacket and also utilize a scarf or head wrap formed of the repellent-treated mesh as described with respect to the wrap jacket.

FIG. 1D depicts a front/side view of a mosquito-repelling wrap jacket as worn according to an embodiment of the present disclosure. In this embodiment, the wrap jacket has been belted to provide a more flattering silhouette for the wearer and make the wearer's outfit more fashion-forward.

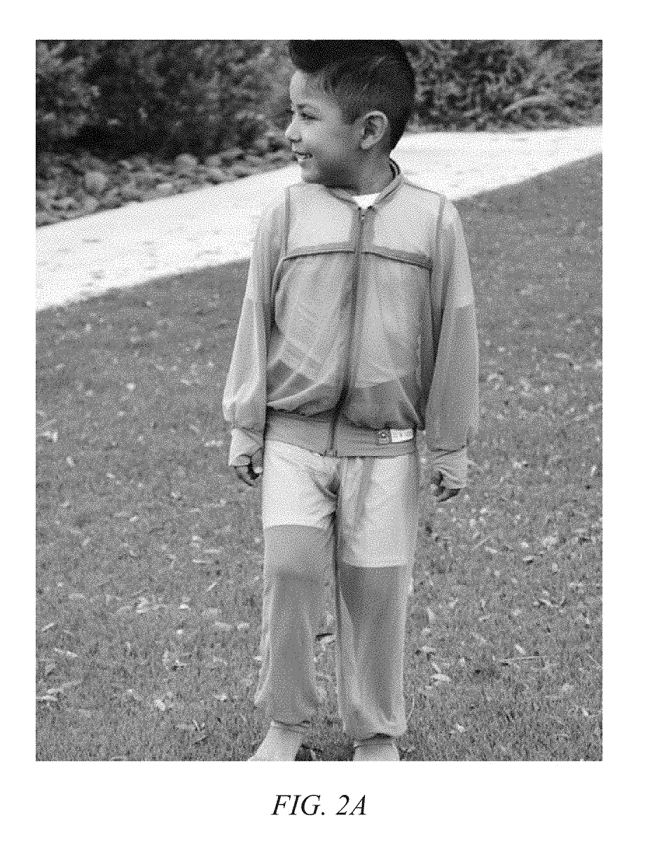

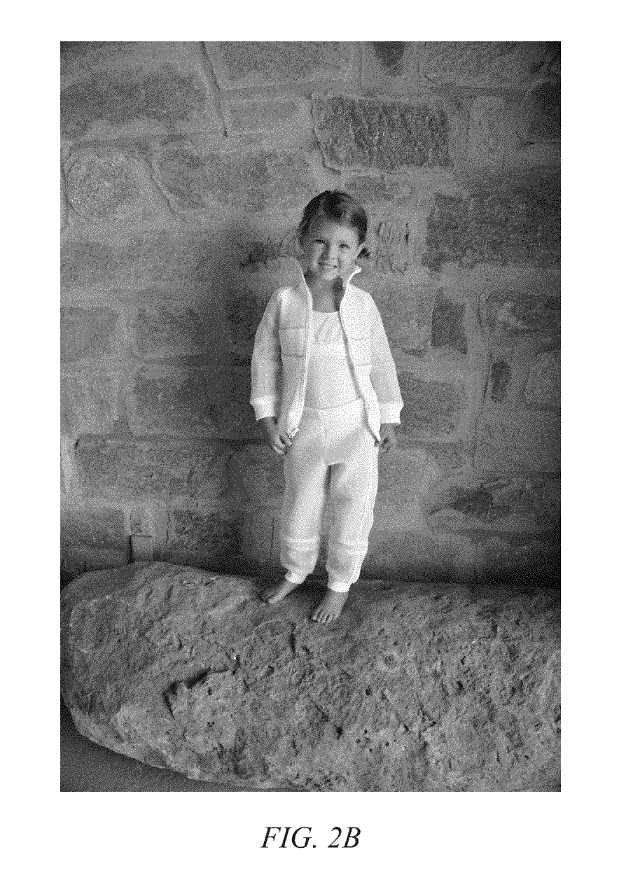

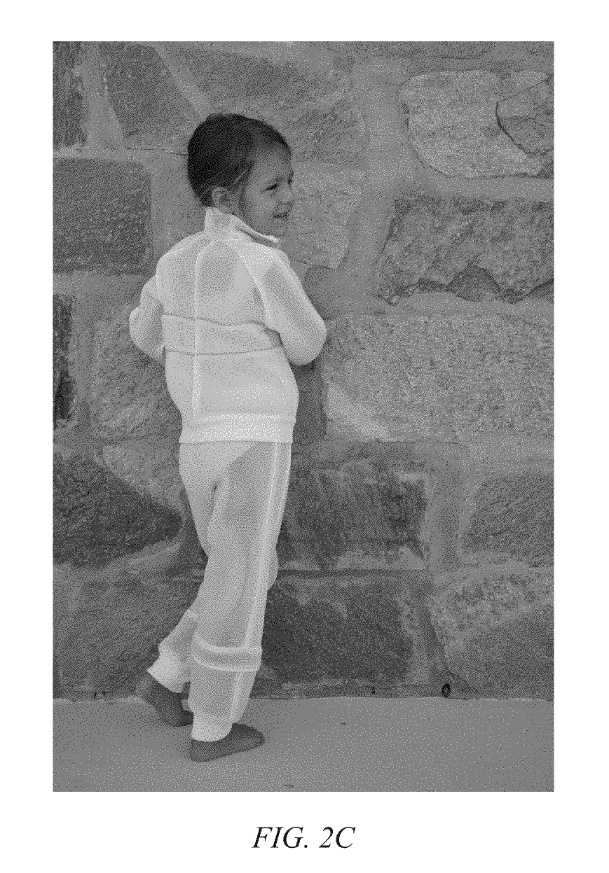

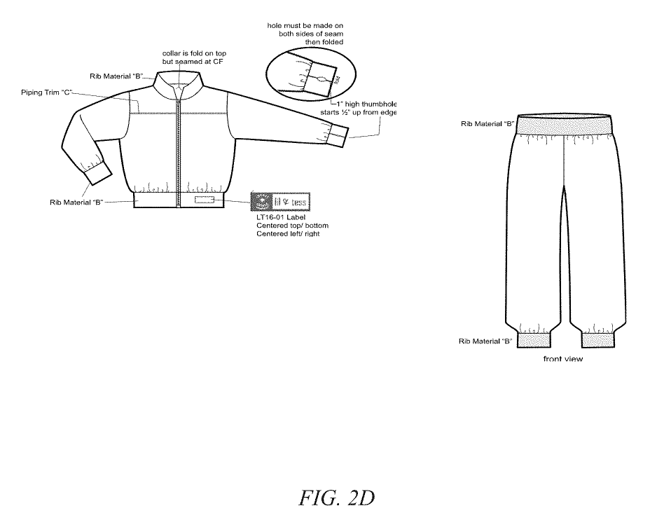

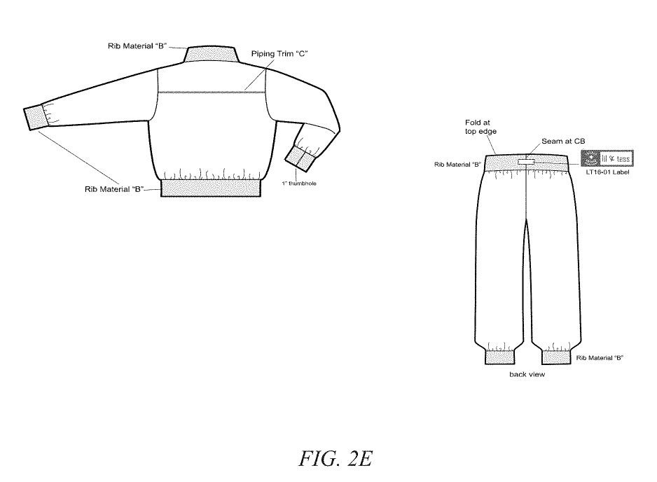

In another embodiment of the present disclosure, a tracksuit (FIGS. 2A-2C) may be constructed of mesh (i.e., a single-layer repellent-treated mesh and/or a three-dimensional mesh, which may or may not be repellent-treated) that is soft and breathable. Such a tracksuit may be provided for adults and children alike. By wearing the tracksuit, a human may be protected from insect bites as the repellent within the mesh fabric is tightly bonded into the actual fibers of the fabric. This may provide built-in protection from mosquitoes, ticks and other potentially dangerous biting insects. Like the net wrap jacket, a tracksuit according to embodiments of the present disclosure may be formed of soft and breathable stretch mesh having a repellent that is effective for approximately 25 launderings.

FIGS. 2A-2C depict different views of mosquito-repelling tracksuits according to embodiments of the present disclosure. More specifically, these FIGURES depict front and back views of children wearing tracksuits according to embodiments of the present disclosure. The trouser portion of the tracksuit may have a waistband, and the trousers may cover the lower torso and legs of the wearer, while the jacket portion may cover the upper torso and arms of the wearer in some embodiments of the present disclosure.

As depicted, these tracksuits are suitable for girls as well as boys and may be provided in a variety of colors, patterns and styles. It also should be appreciated that tracksuits as well as other wearables according to embodiments of the present disclosure may include reflective patterns or other safety/design features.

Further, while the tracksuits of FIGS. 2A-2C are being worn by children, it should be appreciated that these tracksuits may also be formed in sizes/styles to be worn by men and women without departing from the present disclosure. In addition, tracksuits according to embodiments of the present disclosure may be provided in a variety of sizes; however, there may be some embodiments of the present disclosure wherein tracksuits could be provided in a one-size-fits-most style.

FIGS. 2A-2C depict the relatively see-through nature of tracksuits according to embodiments of the present disclosure; accordingly, wearers generally wear the tracksuits in sizes that allow for their regular clothes to fit underneath the track suit when worn.

FIG. 2A provides a front view of a tracksuit according to an embodiment of the present disclosure. In this embodiment, the fabric is formed in a gathered manner at various points of the track suit, particularly at the wrists, the waistband and the ankles of the wearer. This gathering may reduce the likelihood that a mosquito may reach the wearer's skin through one of these more open areas of the tracksuit. The gathering may be a ribbed material in some embodiments of the present disclosure. The tracksuit also may include a collar that may have a fold on top but be seamed at the corner front in some embodiments of the present disclosure. This collar also may be formed of a ribbed material.

FIG. 2A also depicts how the tracksuit according to an embodiment of the present disclosure may have a zippered front closure to allow for easy wearability; the zipper may be attached to the track suit by way of fabric strips; however, other methods of attachment may be used without departing from the present disclosure. It also should be appreciated that there may be other embodiments of the present disclosure where closure mechanisms other than a zipper may be utilized, for example, buttons or Velcro. There may be further embodiments wherein the jacket portion of the track suit may be formed more like a pullover jacket in which case a closure mechanism may not be necessary. In addition, wearable may have reflective portions on one or more sections so that safety can be increase in low-light, hunting, or other similar situations.

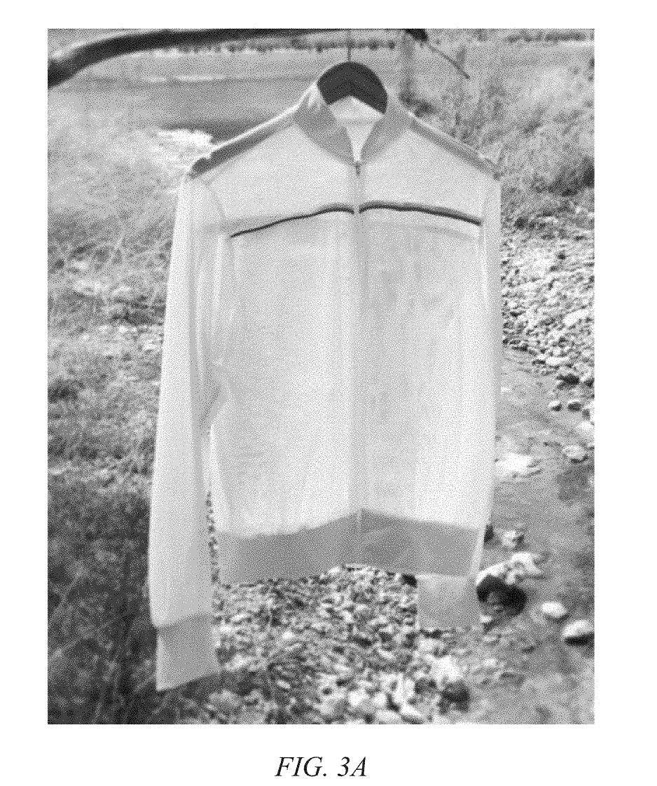

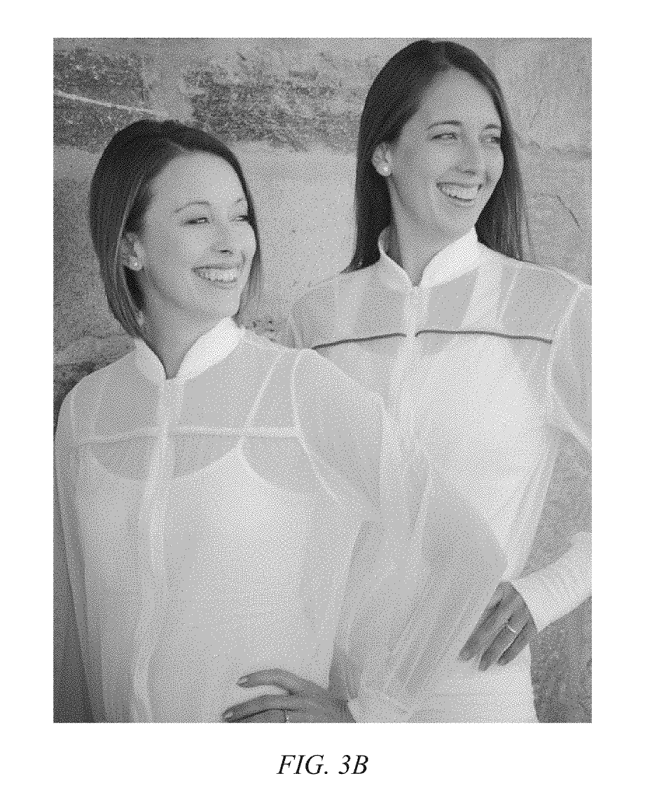

In a further embodiment of the present disclosure, a track jacket (FIGS. 3A-3B) may be provided. This track jacket may be constructed of a single-layer repellent-treated mesh that is soft and breathable as it helps protect the wearer from inspect bites. The repellent within the mesh may be tightly bonded into the actual fibers of the fabric. This may provide built-in protection that helps protect the wearer against mosquitoes, ticks and other potentially dangerous biting insects. Like the other wearables previously described, the track jacket according to embodiments of the present disclosure may be formed of a soft and breathable stretch mesh having a repellent that is effective for approximately 25 launderings.

FIG. 3B depicts how a track jacket according to an embodiment of the present disclosure may cover the upper torso of the wearer in the form of a jacket. While the wearer in FIG. 3B is depicted as a woman, it should be appreciated that jackets may be provided for men and children (boys and girls) as well without departing from the present disclosure.

While not specifically depicted in FIGS. 2A-2C or FIGS. 3A-3B, it should be appreciated that a track suit or track jacket according to embodiments of the present disclosure may include a hood that connects to the track suit or jacket at a neck line.

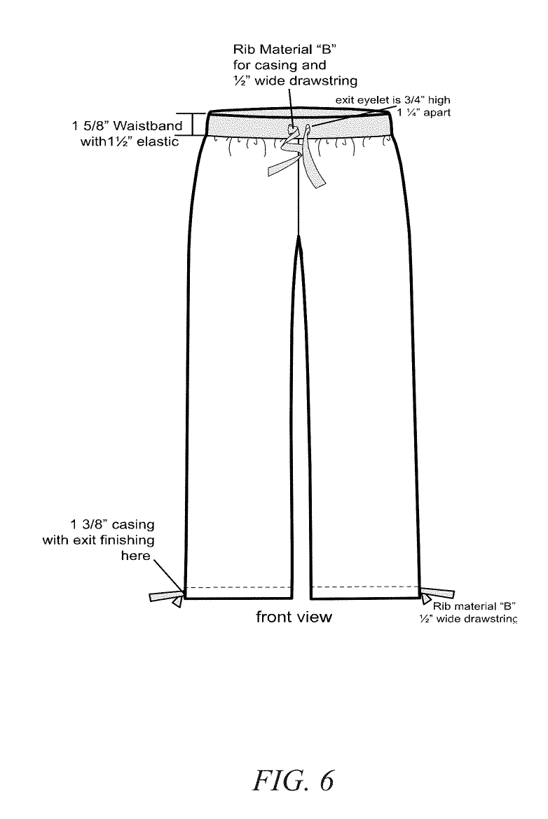

FIG. 6 depicts a view of mosquito-repelling pants according to an embodiment of the present disclosure. Like the pants described in FIGS. 2A-2C, a ribbed material may be utilized to form a waistband; however, the pants in FIG. 6 also depict a drawstring closure. Further, the pants in FIG. 6 also include drawstring closures at the ankle portions of the pants along with ribbed material. While drawstring closures are depicted in FIG. 6, it should be appreciated that these closures may not be utilized in all embodiments of the present disclosure.

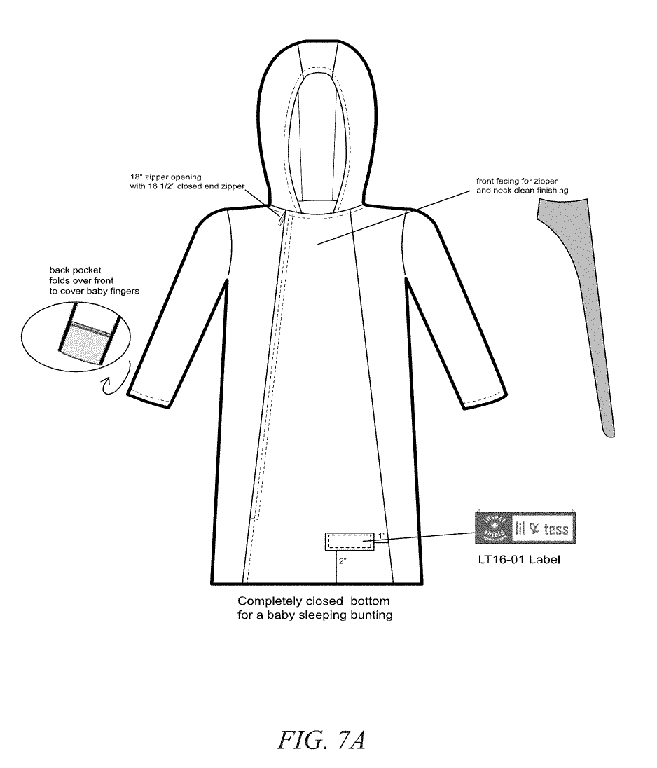

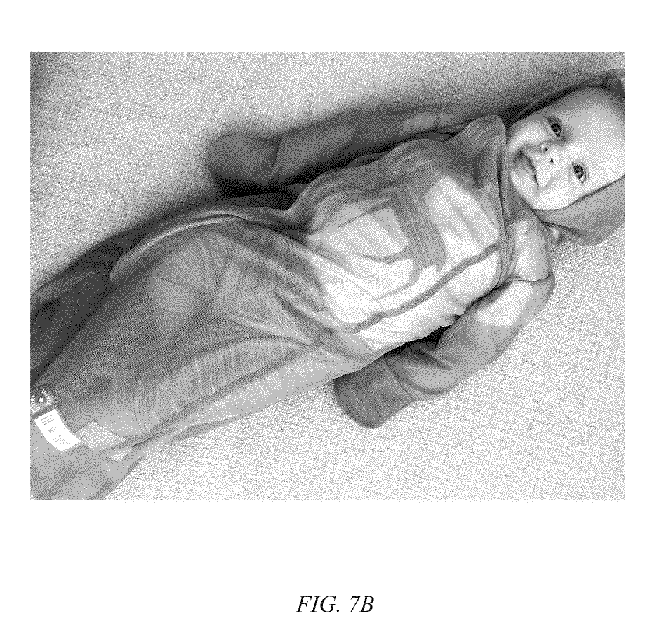

FIG. 7A depicts a view of a mosquito-repelling infant bunting according to an embodiment of the present disclosure. A hood may be provided as depicted in FIG. 7A. The bunting also may include a zipper to open and close the bunting, and the bunting also may include a front face that covers the zipper for cleaner finishing on the bunting. The arm portions of the bunting may include back pocket folds over the front to cover the infant's fingers in some embodiments of the present disclosure. The bunting as depicted in FIG. 7A may provide a completely closed bottom, such as when the bunting may be employed for a sleeping infant; however, it should be appreciated that there may be embodiments of the present disclosure where the bunting may not be completely closed and/or may not be used for a sleeping infant. FIG. 7B depicts a view of a mosquito-repelling infant bunting being worn by an infant according to an embodiment of the present disclosure.

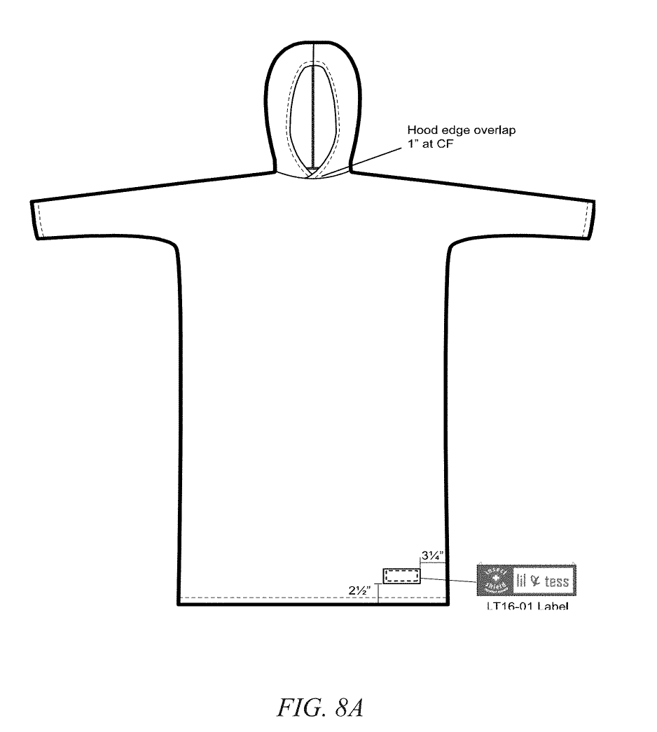

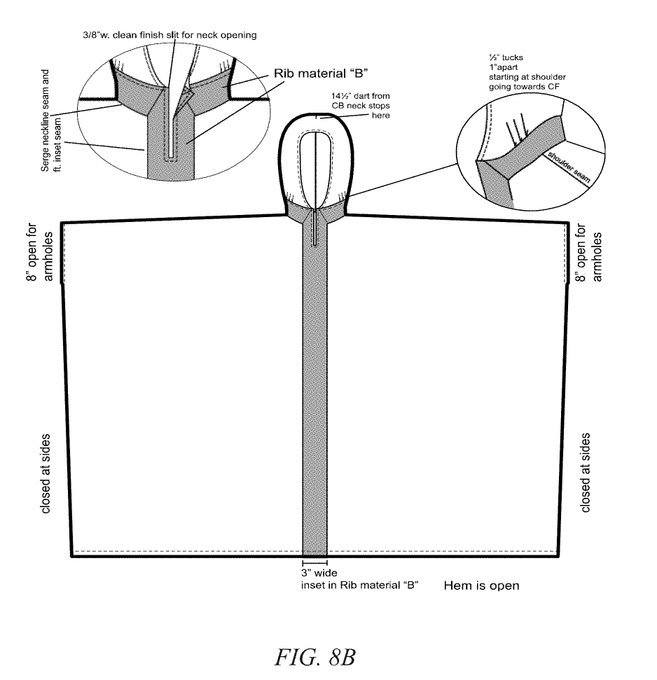

FIGS. 8A and 8B depict mosquito-repelling cover-ups according to an embodiment of the present disclosure. More specifically, FIG. 8A depicts a front view of a cover-up including a hood where there is an overlapping edge between the hood and the body portion of the cover-up to improve skin coverage when worn. FIG. 8B depicts a cover-up that includes a hood, and this cover-up also includes a neck portion formed of a ribbed material. In some embodiments of the present disclosure, the neck portion may include a slit for the neck opening and/or a serge neckline seam. It should be appreciated that a cover-up may include openings for the arms to be received but otherwise may be closed at the sides.

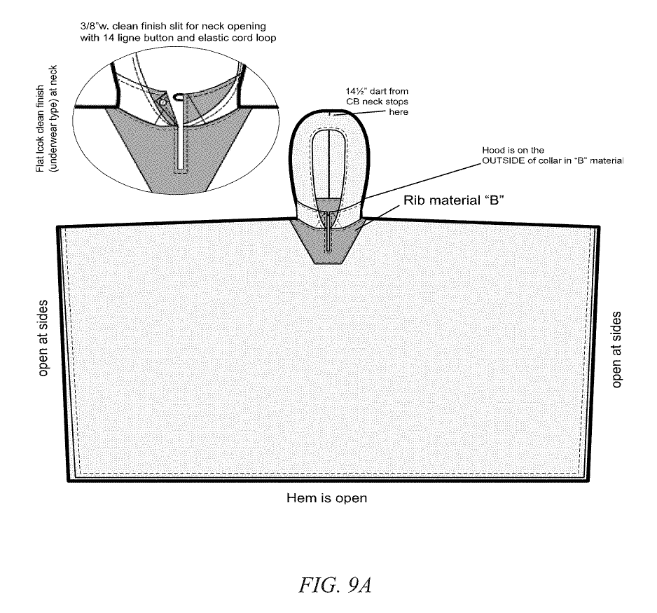

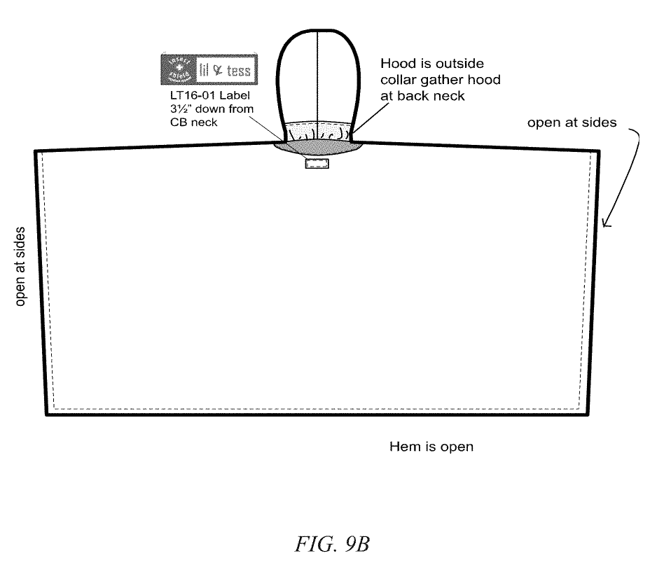

FIG. 9A depicts a front view of a mosquito-repelling poncho according to an embodiment of the present disclosure, and FIG. 9B depicts a back view of a mosquito-repelling poncho according to an embodiment of the present disclosure. As depicted herein, a poncho may include a hood that may be placed on the outside of the collar portion. A poncho may differ from the cover-ups depicted in FIGS. 8A and 8B at least insofar as the poncho is open at the sides (i.e., does not contain armholes). The neck portion of the poncho as depicted in FIGS. 9A and 9B may include a ribbed material, and it also may include a button, elastic cord loop or another fastening mechanism around the neck portion to secure the poncho in place in some embodiments of the present disclosure. As depicted in FIG. 9B, the hood is outside the collar portion at the back of the wearer's neck and may be gathered as described in other embodiments of the present disclosure.

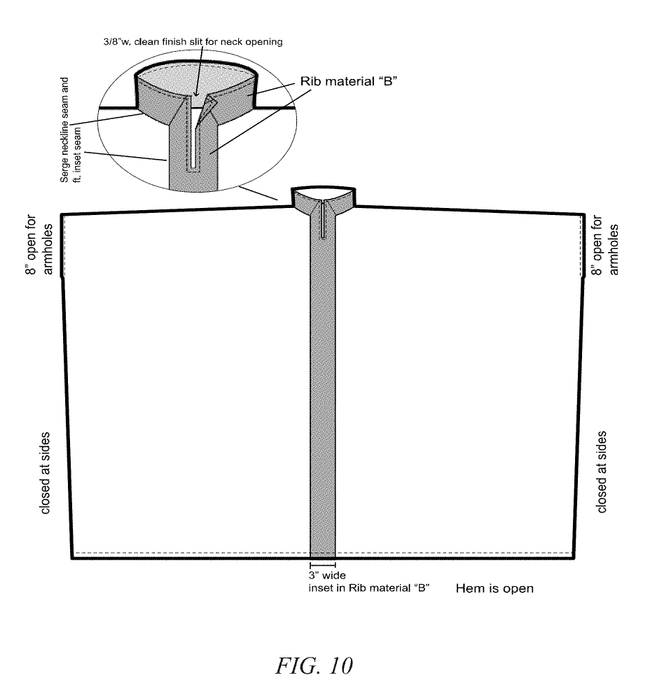

FIG. 10 depicts a front view of a mosquito-repelling caftan cover-up according to an embodiment of the present disclosure. The caftan cover-up of FIG. 10 is similar to the cover-ups and/or ponchos previously described in that it may include ribbed material around the neck portion; however, it does not include a hood portion.

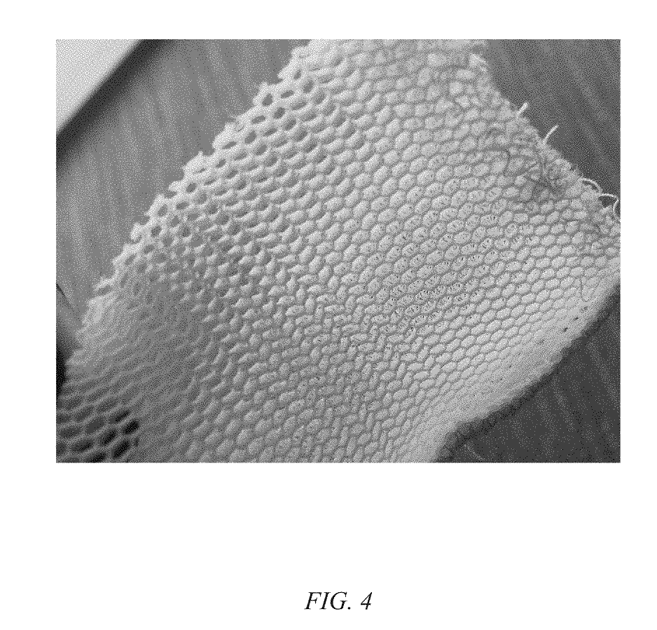

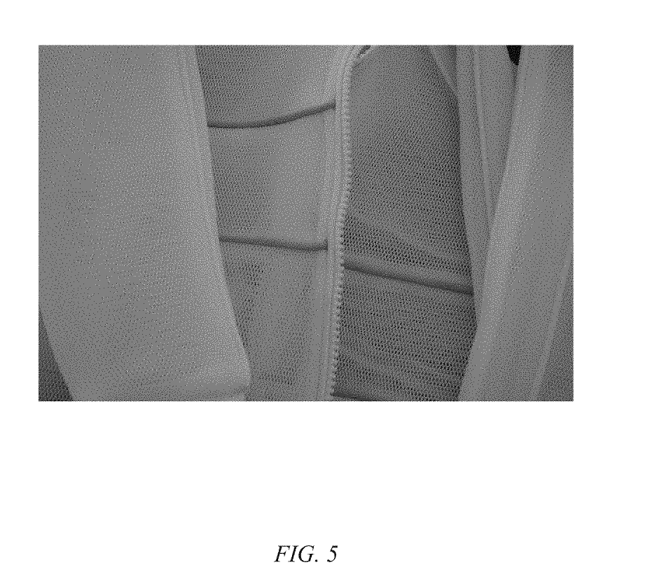

FIG. 4 depicts a mosquito-repelling mesh according to an embodiment of the present disclosure, and FIG. 5 depicts a close-up view of a mosquito-repelling fabric forming the track jackets of FIGS. 3A and 3B. While embodiments of the present disclosure have been described as having repellent within the mesh fabric tightly bonded into the actual fibers of the fabric, it should be appreciated that the repellent also may be woven into the fabric or may be sprayed onto or otherwise applied to the fabric without departing from the present disclosure. In addition, the mosquito-repelling fabric, in one embodiment, can be three-dimensional fabric/mesh, such as depicted in FIGS. 2B and 2C. This three-dimensional mesh may or may not be repellent-treated in embodiments of the present disclosure.

The type of fabric used to form wearables according to embodiments of the present disclosure may depend on the type of wearable. For example, a tracksuit may be formed from a combination of sheer stretch or spandex mesh (approximately 82% nylon and approximately 18% spandex) and milliskin tricot (approximately 80% nylon and approximately 20% spandex) while a wrap jacket may be formed of just the sheer stretch or spandex mesh (i.e., no milliskin tricot). There also may be embodiments of the present disclosure where a three-dimensional mesh may be used in addition to or in place of the sheer stretch or spandex mesh and/or milliskin tricot. This three-dimensional mesh may or may not be repellent-treated in embodiments of the present disclosure. However, it should be appreciated that other similar materials may be utilized without departing from the present disclosure. The fabric forming wearables according to embodiments of the present disclosure may have a spongy or springiness that may resist compression and reduction in thickness of the fabric when in use; this may lessen the likelihood that the insect stinger penetrates the wearer's skin. The fabric also may provide for sufficient ventilation such that the resultant wearable is not too hot to wear when the weather is warm or when the wearer is engaging in physical activity.

Regardless the composition of the fabric, the fabric, particularly with respect to a three-dimensional mesh, should be formed of sufficient thickness to prevent an insect stinger bite from penetrating the skin of the wearer. This thickness may be approximately ⅛ inches thick; however, the fabric may be thicker or thinner without departing from the present disclosure. Further, the mesh pattern should be formed in such a way that the distance between the wearer's skin and the insect stinger is as large as possible. Also, because of the tightly woven nature of the fabric, the stinger is less likely to penetrate the fabric due to the lack of passageways through the fabric; this is where the 3-D nature of the fabric also may be helpful. Thus, wearables according to embodiments of the present disclosure may place the repellent near the wearer's skin instead of being applied to the skin itself. The repellent nature is long-lasting and does not have to be reapplied to the fabric.

In addition, the wearables may also include sensors, GPS sensors, Bluetooth sensors, Wi-Fi sensors, watches, heart rate monitor, humidity sensor, phone, touchscreen, display, graphical user interface, voice recognition interface, temperature sensor, watch, blood sugar monitor, panic button, camera, drone interface, LTE/Wi-Fi/Bluetooth communication processors/sensors, used either alone or in combination with one another, to better improve the use of the wearable.

While the embodiments described herein have focused on wearables for humans, there also may be embodiments of the present disclosure wherein pets, such as dogs and cats, may be provided with wearables that may reduce the risk of mosquito bites. For example, a jacket or vest may be provided that may be formed of repellent-treated mesh that a dog may wear when he/she is being walked outside.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A mosquito-repelling wearable comprising:
a repellent-treated mesh that is soft and breathable, wherein the repellent tightly bonds a permethrin formulation into fibers of the mesh.

2. The mosquito-repelling wearable of claim 1, wherein the wearable is selected from the group comprising:
a track suit, a poncho, a caftan cover-up, a cover-up, a bunting, a jacket, a wrap, a pant covering, a wrist band, a hat, shorts, pants, a collar shirt, athletic wear, a scarf, and a patch.

3. The mosquito-repelling wearable of claim 1, wherein the mesh is a three-dimensional mesh.

4. The mosquito-repelling wearable of claim 1, wherein the mesh is a single-layer repellent-treated stretch mesh.

5. The mosquito-repelling wearable of claim 4, wherein the single-layer repellent-treated stretch mesh comprises:
sheer stretch mesh formed of approximately 82% nylon and approximately 18% spandex; and
milliskin tricot formed of approximately 80% nylon and approximately 20% spandex.

6. The mosquito-repelling wearable of claim 4, wherein the single-layer repellent-treated stretch mesh is comprised of sheer stretch mesh formed of approximately 82% nylon and approximately 18% spandex.

7. The mosquito-repelling wearable of claim 1, wherein the mesh is a single-layer repellent-treated stretch mesh and a three-dimensional mesh.

8. The mosquito-repelling wearable of claim 1, wherein the repellent nature of the wearable lasts for approximately 25 launderings.

9. The mosquito-repelling wearable of claim 1, wherein the mesh is stretchy and pliable.

10. The mosquito-repelling wearable of claim 1 further comprising:
a belting mechanism to provide closure for a front portion of the wearable.

11. The mosquito-repelling wearable of claim 1, wherein the wearable is a track suit having a trouser portion that covers a lower torso and legs of a wearer and a jacket portion that covers an upper torso and arms of the wearer.

12. The mosquito-repelling wearable of claim 1, wherein the wearable has a springiness that resists compression and reduction in thickness of the mesh when in use, thereby lessening the likelihood that a stinger of the mosquito penetrates a wearer's skin.

13. The mosquito-repelling wearable of claim 1, wherein the wearable has sufficient ventilation to permit wearing during hot weather or when engaging in physical activity.

14. The mosquito-repelling wearable of claim 1, the wearable further comprising:
sensors, GPS sensors, Bluetooth sensors, Wi-Fi sensors, watches, heart rate monitor, humidity sensor, phone, touchscreen, display, graphical user interface, voice recognition interface, temperature sensor, watch, blood sugar monitor, panic button, camera, drone interface, and LTE/Wi-Fi/Bluetooth communication processors/sensors.

15. The mosquito-repelling wearable of claim 1, wherein the mesh has a sufficient thickness to prevent a mosquito stinger bite from penetrating a wearer's skin.

16. The mosquito-repelling wearable of claim 15, wherein the thickness is approximately ⅛ inches thick.

17. A mosquito-repelling tracksuit comprising:
a trouser portion that covers a lower torso and legs of a wearer, the trouser portion including gatherings at the waistband and ankles formed of a ribbed material; and
a jacket portion that covers an upper torso and arms of the wearer, the jacket portion including gatherings at the neck and wrists formed of the ribbed material,
wherein the trouser portion and the jacket portion are formed of a repellent-treated three-dimensional mesh that is soft and breathable, wherein the repellent tightly bonds a permethrin formulation into fibers of the mesh.

18. A mosquito-repelling cover-up comprising:
a body portion formed of a single-layer repellent-treated mesh comprised of sheer stretch mesh formed of approximately 82% nylon and approximately 18% spandex, wherein the repellent tightly bonds a permethrin formulation into fibers of the mesh.

19. The mosquito-repelling cover-up of claim 18 further comprising:
a collar portion formed of a ribbed material and attached to the body portion.

20. The mosquito-repelling cover-up of claim 19 further comprising:
a hood attached to the collar portion of the cover-up, the hood formed of the repellent-treated three-dimensional mesh.
